(19) United States
(12) Patent Application Publication
(10) Pub. No.: US 2007/0013942 A1
(43) Pub. Date: Jan. 18, 2007

(54) Data communication system, image processing device, and method for managing data in image processing device

(75) Inventors: Kaitaku Ozawa, Amagasaki-shi (JP); Kenichi Takahashi, Sennan-gun (JP); Toshiya Shozaki, Osaka-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/235,171

(22) Filed: Sep. 27, 2005

(30) Foreign Application Priority Data
Jul. 14, 2005 (JP) 2005-206218

(51) Int. Cl. G06F 3/12; G06F 15/00

(52) U.S. Cl. 358/1.15; 358/448; 358/402

(57) ABSTRACT

An image forming device is provided with a job execution control portion for executing a job, a personal box for storing a file that is obtained by executing a job or the like, and an image file transmission portion for transmitting the user's file stored in the personal box to another image processing device that the user uses mainly if the user who logged in to the image forming device is a guest user who uses the other image forming device mainly.

This application is based on Japanese Patent Application No. 2005-206218 filed on Jul. 14, 2005, the contents of which are hereby incorporated by reference.

### BACKGROUND OF THE INVENTION

1. Field of the Invention

The present invention relates to an image processing device such as MFP and a method for managing data in the image processing device.

2. Description of the Prior Art

Conventionally, an image processing device having various functions of a copying machine, a scanner, a network printer, a fax machine and the like, which is called multi function peripherals (MFP) or a multifunction device, has become commonplace in a office or the like.

Recently, such an image processing device has been equipped with a LAN interface and a large capacity hard disk drive for being used as a document server. According to a function of the document server, each user who uses the image processing device is given a storage area called a “box” or a “personal box” that corresponds to a folder or a directory in a personal computer. Then, each user can store image data or the like in his or her box. This function may be called a “box function”.

There is also provided a method for enabling another device to use data stored in the personal box of the image processing device. For example, Japanese unexamined patent publication No. 2003-304370 discloses a method in which a user can move data stored in a user box (personal box) in an image processing device to a personal computer for using the same.

Plural image processing devices may be installed in an office, and user may want to use the image processing devices effectively. Therefore, a system is proposed as described in Japanese unexamined patent publications No. 2002-49478, and No. 2000-293337.

A data output system described in Japanese unexamined patent publication No. 2002-49478 includes an output device, an information processing device and an information storing device that are connected to each other via a network, so that data obtained or produced by an information processing device used by an information provider is delivered from the output device. The data output system includes, user tracking portion for tracking a position of an information user who uses the data, an information moving portion for moving the data to the information storing device corresponding to a tracked position of the information user, and an output executing portion for executing output of data that were moved and stored in the information storing device in accordance with an instruction from the information processing device that the information user uses. According to this structure, the information user can output data from an information storing device such as a server nearest the user.

In a printing system disclosed in Japanese unexamined patent publication No. 2000-293337, plural printing devices are connected via a network and are grouped based on a language that can be processed by them, and one of the printing devices that belong to the same language group is to be a management printing device. The management printing device receives status signals from all the printing devices that belong to the same language group. If one of the printing devices is disabled to print, the management printing device delivers print job data from the printing device to another printing device that belongs to the same language group. According to this structure, it is possible to print without waiting time when a printing device that received print job data cannot execute the print job because of a certain cause.

Most users use predetermined image processing devices in most cases. For example, a user who is an employee working for a company including plural branch offices ordinarily and mainly uses an image processing device that is installed nearest the user in a branch office where he or she is working. The user may be provided with a personal box for him or her in the image processing device that he or she uses mainly so that his or her data can be stored in the personal box.

The user may visit another branch office on business and use an image processing device that is installed there. If the user needs to save data obtained by using the image processing device for reusing the data in a business trip destination, he or she may store the data not in the image processing device that he or she ordinarily uses but temporarily in the image processing device that is installed in the business trip destination.

In this case, however, the user has to access the image processing device that is installed in the business trip destination from his or her branch office after coming back to his or her branch office from the business trip, so as to use the data that are stored in the image processing device in the business trip destination and to copy the data to the image processing device that he or she uses ordinarily.

Therefore, the user has to access the image processing device that is installed in the business trip destination from his or her branch office much time and with effort. In addition, if the image processing device that is installed in the business trip destination is in the power-down state, the data cannot be retrieved. In this case, the user has to ask another user in the business trip destination to turn on the image processing device.

### SUMMARY OF THE INVENTION

An object of the present invention is to provide a system and device that enables a user to handle data obtained in an image processing device that the user rarely uses in a more convenient manner than the conventional system or device.

A data communication system according to the present invention includes a first device and a second device that can be connected to each other via a communication line. The first device is equipped with a first data storage portion for storing data of a user who uses the first device mainly. The second device is equipped with a second data storage portion for storing data that are owned by the user and are obtained during a period after the user logs in to the second device until the user logs out, a data transmission portion for transmitting data to the first device after the user logs out the device if the data stored in the second storage portion is data owned by the user who uses the first device mainly, and a data deleting portion for deleting the data that were transmitted to the first device from the second storage portion.

An image processing device according to the present invention is an image processing device for executing an image-related process that is a process about an image. The image processing device includes a data obtaining portion for obtaining data by executing the image-related process, a data storage portion for storing data obtained by the data obtaining portion, and a data transmission portion for transmitting data that are owned by the user and are obtained by the data obtaining portion to another image processing device if the user who logged in to the image processing device is a guest user who uses another image processing device mainly.

Preferably, the image processing device includes a data deleting portion for deleting data that were transmitted to the other image processing device by the data transmission portion from the data storage portion.

In the present invention, the image-related process includes a process such as copy or scan of an original, or image correction. It also includes transmission and reception or copy of image data.

According to the present invention, data that are obtained by an image processing device that is not used regularly by the user can be handled in a more convenient manner than the conventional system or device.

According to the present invention, risk of leakage of data can be reduced in comparison with the conventional system or device.

### BRIEF DESCRIPTION OF THE DRAWINGS

FIG. 1 is a diagram showing an example of an overall structure of an intranet.

FIG. 2 is a diagram showing an example of a hardware structure of an image forming device.

FIG. 3 is a diagram showing an example of a control panel.

FIG. 4 is a diagram showing an example of a functional structure of the image forming device.

FIG. 5 is a flowchart showing an example of a flow of a user authentication process.

FIG. 6 is a flowchart showing an example of a flow of a general process of the image forming device.

FIGS. 7(a) and 7(b) are diagrams showing examples of an inbox file list screen.

FIG. 8 is a flowchart showing an example of a flow of a file transmission process.

FIG. 9 is a flowchart showing an example of a flow of a file reception process.

FIG. 10 is a flowchart showing a variation of a flow of a process by the image forming device.

FIG. 11 is a flowchart showing a variation of a flow of a process by the image forming device.

FIG. 12 is a flowchart showing an example of a flow of a process by the image forming device when a link button is selected.

FIG. 13 is a flowchart showing a variation of a flow of a process by the image forming device.

FIG. 14 is a flowchart showing an example of a flow of a process by the image forming device when an away user logs in again.

### DESCRIPTION OF THE PREFERRED EMBODIMENTS

Hereinafter, the present invention will be explained more in detail with reference to embodiments and drawings.

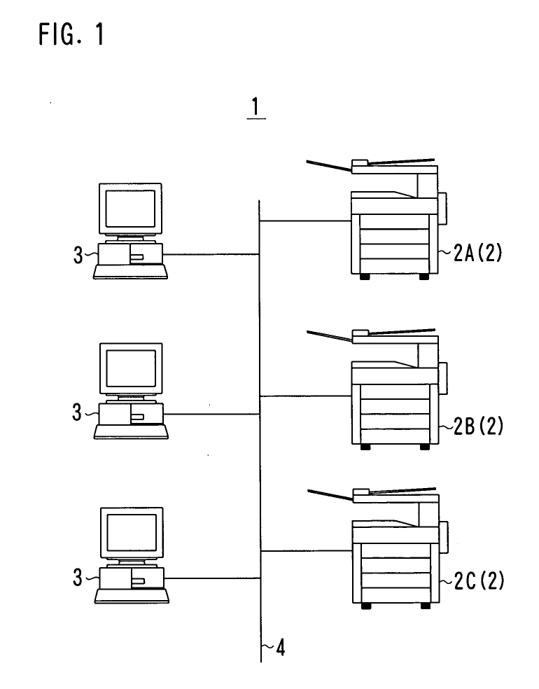

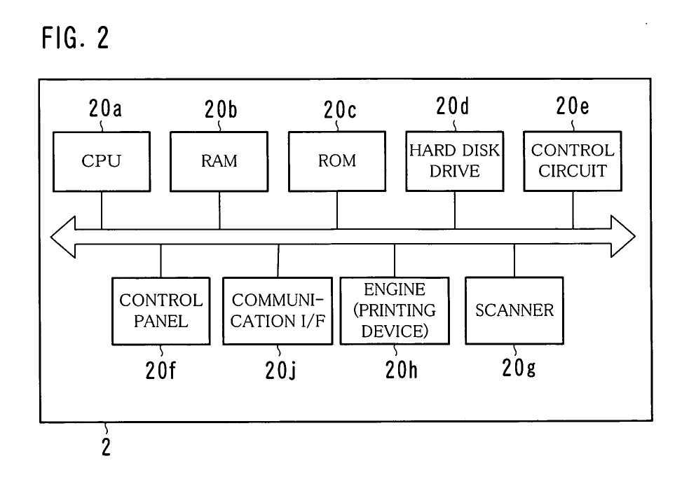

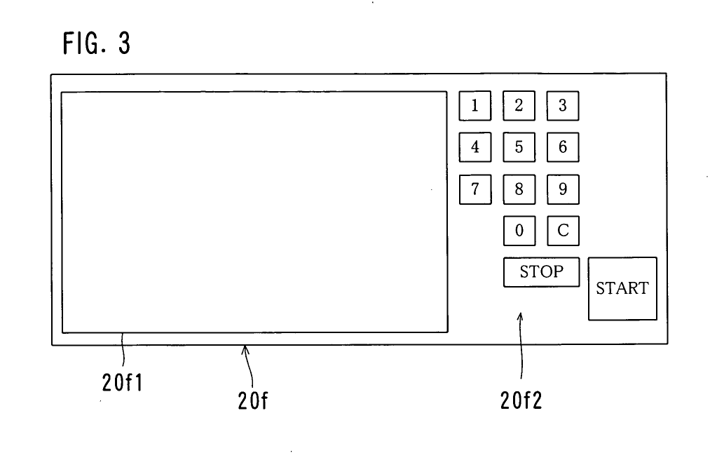

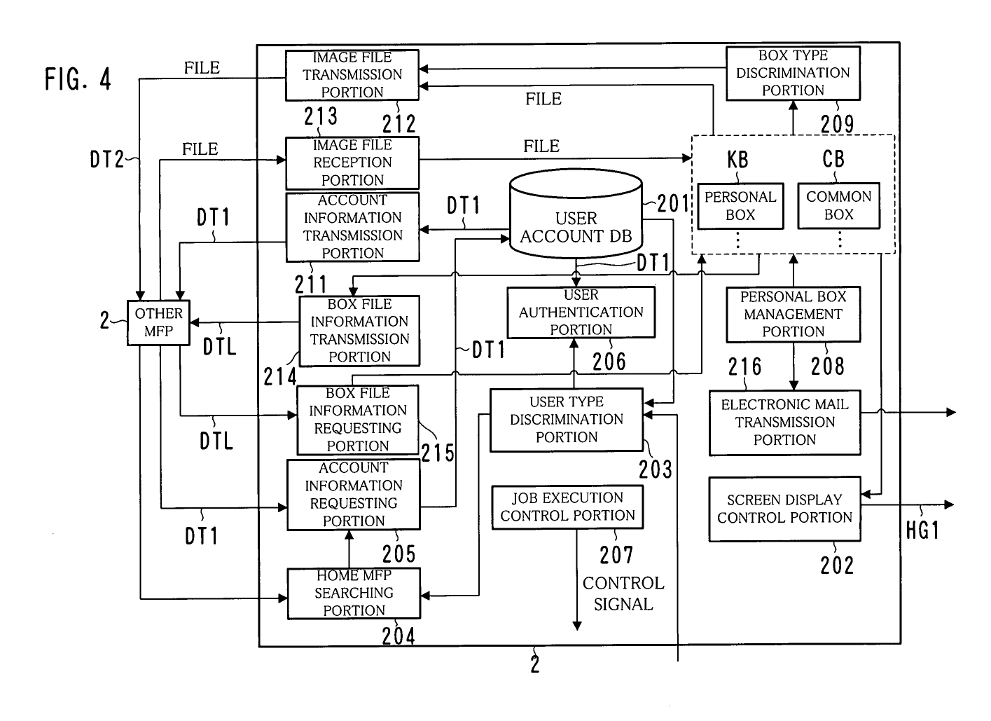

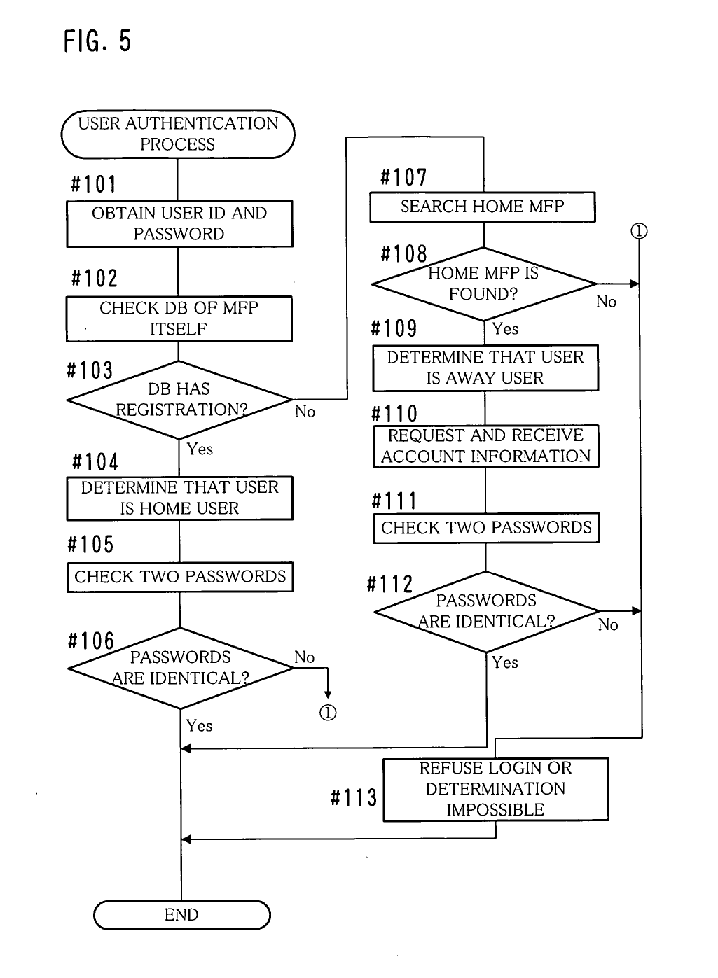

FIG. 1 is a diagram showing an example of an overall structure of an intranet 1, FIG. 2 is a diagram showing an example of a hardware structure of an image forming device 2, FIG. 3 is a diagram showing an example of a control panel 20f, FIG. 4 is a diagram showing an example of a functional structure of the image forming device 2, and FIG. 5 is a flowchart showing an example of a flow of a user authentication process.

The intranet 1 includes a plurality of image forming devices 2, a plurality of terminal devices 3, and a communication line 4 as shown in FIG. 1, so that various image processes are performed. In other words, the intranet 1 forms an image processing system.

The image forming device 2 and the terminal device 3 of the intranet 1 are connected to each other via the communication line 4. As the communication line 4, the Internet, a LAN, a public telephone line or a private line can be used. These devices transmit and receive data by a protocol such as FTP (File Transfer Protocol).

This intranet 1 is established in a facility such as a company, a public office or a school. Moreover, if the intranet 1 is established in a company for example, each branch office or sales station of the company is provided with one or more of the image forming devices 2 and the terminal devices 3. A unique IP address is assigned to each of the image forming devices 2 and the terminal devices 3.

Hereinafter, an example will be described where three of the image forming devices 2 are included in the intranet 1. Furthermore, these three image forming devices 2 may be referred to separately as the “image forming device 2A”, the “image forming device 2B” and the “image forming device 2C”.

The image forming device 2 is an image processing device that executes various processes about images, and has various integrated functions including copy, scanner, fax, network printing, file transmission, electronic mail and document server. It is also called a multifunction device or MFP (Multi Function Peripherals).

According to the network printing function, image data can be received from the terminal device 3 so that images are printed on paper. It is also called a “network printer function” or a “PC print function”. Moreover, according to the document server function, each user who uses the image forming device 2 is provided with a storage area that is called a “box” or a “personal box” and corresponds to a folder or a directory of a personal computer. The user can save his or her image data as a file in his or her box. This function is also called a “box function”.

As shown in FIG. 2, the image forming device 2 includes a CPU 20a, a RAM 20b, a ROM 20c, a hard disk drive 20d, a control circuit 20e, a control panel 20f, a scanner 20g, a printing device 20h, and a communication interface 20j.

The scanner 20g is a device for optically reading images including photographs, characters, pictures and charts on a sheet of an original (hereinafter referred to as an “original” simply) and producing image data. The printing device 20h is a device for printing an image in accordance with an image read by the scanner 20g or image data transmitted from the terminal device 3 or the like.

The control panel 20f is made up of a display device 20f1 and a control button unit 20f2 including a plurality of control buttons as shown in FIG. 3.

The control button unit 20f2 is made up of a plurality of keys for entering numbers, characters or signs, a sensor for recognizing a pressed key, and a transmission circuit for transmitting a signal indicating a recognized key to the CPU 20a.

The display device 20f1 displays a screen for giving a message or an instruction to a user who operates this image forming device 2, a screen for the user to enter a type and process conditions of a desired process, and a screen for showing a process result. In this embodiment, a touch panel is used for the display device 20f1. Therefore, the display device 20f1 has a function of detecting a position on the touch panel where a user touches with a finger, and a function of sending a signal indicating a detection result to the CPU 20a.

In this way, the control panel 20f plays a role as a user interface for a user who operates the image forming device 2 directly. Note that an application program and a driver for instructing the image forming device 2 are installed in the terminal device 3. Therefore, the user can also operate the image forming device 2 from a remote location by using the terminal device 3.

A communication interface 20j is shown in FIG. 2, which is an NIC (Network Interface Card) for communicating with the image forming device 2 or the terminal device 3 and a modem for communicating with a fax terminal outside the intranet 1.

The control circuit 20e is a circuit for controlling devices including the hard disk drive 20d, the scanner 20g, the printing device 20h, the communication interface 20j and the control panel 20f.

The hard disk drive 20d is provided with an area for a personal box KB of each user. In this embodiment, a user can have the personal box KB only in one of the image forming devices 2 basically, which the user uses mainly. For example, the personal box KB of the user who uses the image forming device 2A mainly is provided only to the hard disk drive 20d of the image forming device 2A. As being described later, however, there is the case where the personal box KB of the user who does not use mainly is provided temporarily. The user can save a file owned by him or her in the personal box KB.

Hereinafter, the image forming device 2 that the user mainly uses is referred to as a “home MFP”, and other image forming device 2 is referred to as an “away MFP”. In addition, for the image forming device 2, the user who uses the image forming device 2 mainly is referred to as a “home user”, and the user who uses other image forming device 2 mainly is referred to as an “away user” or a “guest user”. For example, it is supposed that the user Ux uses the image forming device 2A mainly and the user Uy uses the image forming device 2B mainly. Then, the image forming device 2A is a home MFP for the user Ux, and the image forming devices 2B and 2C are away MFPs for the user Ux. In contrast, the image forming device 2B is a home MFP for the user Uy, and the image forming devices 2A and 2C are away MFPs for the user Uy. In this case, for the image forming device 2A, the user Ux is a home user while the user Uy is an away user. Similarly, for the image forming device 2B, the user Uy is a home user while the user Ux is an away user. For the image forming device 2C, the users Ux and Uy are both away users.

The personal box KB is associated with a user ID of the user who owns the personal box KB so that its owner can be distinguished. In other words, the user ID is used as a box name of the personal box KB, too.

In addition, programs and data are stored in the hard disk drive 20d so as to realize functions of a user account database 201, a screen display control portion 202, a user type discrimination portion 203, a home MFP searching portion 204, an account information requesting portion 205, a user authentication portion 206, a job execution control portion 207, a personal box management portion 208, a box type discrimination portion 209, an account information transmission portion 211, an image file transmission portion 212, an image file reception portion 213, a box file information transmission portion 214, a box file information requesting portion 215, and an electronic mail transmission portion 216 as shown in FIG. 4. These programs are loaded to the RAM 20b as necessity so that the CPU 20a can execute the programs. A part or a whole of these programs or data can be stored in the ROM 20c. Alternatively, it is possible to realize a part or a whole of the functions shown in FIG. 4 by the control circuit 20e.

As described above, the application program and the driver corresponding to the image forming device 2 is installed in the terminal device 3 shown in FIG. 1. As the terminal device 3, a personal computer, a workstation or a PDA (Personal Digital Assistant) can be used.

In FIG. 4, the user account database 201 saves (stores) user account information DT1 of a home user, i.e., a user whose home MFP is the image forming device 2 including the user account database 201. One piece of user account information DT1 is assigned to one home user. The user account information DT1 includes a user ID, a password and an electronic mail address of the user who is given the same. Other than this, the user account database 201 saves (stores) history information DT2 of each home user about usage of each device included in the intranet 1. The history information DT2 is associated with a user ID of the user who is given the same. Furthermore, the user account database 201 may store temporarily the user account information DT1 and the history information DT2 of an away user as being described later.

The screen display control portion 202 performs a process for displaying a predetermined screen at a predetermined timing on the display device 20f1 of the control panel 20f. If nobody logs in to the image forming device 2 for example, a log-in screen for entering a user ID and a password is displayed. If a user presses a predetermined button, a job designation screen for entering a job execution instruction and its process conditions of a job such as copy, scan or fax transmission is displayed. If a user uses the image forming device 2 from remote location by operating the terminal device 3, screen data are transmitted to the terminal device 3 so that the screen can be displayed on the display device of the terminal device 3.

The user type discrimination portion 203 determines whether the user who is going to use the image forming device 2 is a home user or an away user. If the user type discrimination portion 203 determines that the user is an away user, the home MFP searching portion 204 searches the image forming device 2 that is a home MFP for the user. The account information requesting portion 205 performs a process of requesting user account information DT1 of the user from the home MFP searched by the home MFP searching portion 204 and receiving the same.

The user authentication portion 206 performs a process of determining whether or not the user who is going to use the image forming device 2 is an authorized user (i.e., user authentication process) in accordance with the user account information DT1 saved in the user account database 201 or the user account information DT1 received from the other image forming device 2.

The account information transmission portion 211 performs a process of extracting the user account information DT1 requested by the other image forming device 2 from the user account database 201 and transmitting the same to the other image forming device 2.

Here, a flow of the process for the user authentication will be described with reference to the flowchart shown in FIG. 5, using an example of the case where a user is going to use the image forming device 2A.

When the user enters his or her own user ID and password in the state where the log-in screen is displayed on the image forming device 2A (#101), the user type discrimination portion 203 searches the user account information DT1 indicating the user ID from the user account database 201 of the image forming device 2A itself (i.e., a local one) (#102). If the user account information DT1 is found (Yes in #103), it is determined that the user is a home user for the image forming device 2A (#104).

The user authentication portion 206 compares the password indicated in the user account information DT1 with the password entered in the step #101 (#105). If the both passwords are identical (Yes in #106), the user is allowed to log in to the image forming device 2A. Thus, the user can use the image forming device 2A until logging out.

In contrast, if the user account information DT1 is not found (No in #103), the home MFP searching portion 204 searches the home MFP of the user (#107). More specifically, it checks whether or not the user account information DT1 indicating the user ID entered in the step #101 is stored in the user account database 201 of another image forming device 2. If the image forming device 2 that has the user account information DT1 is found, it is determined that the image forming device 2 is the home MFP for the user.

If the home MFP is found (Yes in #108), the user type discrimination portion 203 determines that the user is an away user for the image forming device 2A (#109). The account information requesting portion 205 requests the home MFP to send the user account information DT1 of the user and receives the same (#110). In this case, concerning this home MFP, the account information transmission portion 211 performs the process of extracting the requested user account information DT1 from the local user account database 201 of the home MFP itself and transmitting the same to the image forming device 2A.

Then, the user authentication portion 206 of the image forming device 2A compares the password indicated in the received user account information DT1 with the password entered in the step #101 (#111). If the both passwords are identical (Yes in #112), the user is allowed to log in to the image forming device 2A. Thus, the user can use the image forming device 2A until logging out.

If the both passwords are not identical in the step #105 (No in #106), there is possibility that the person who did the entry operation is not the user. Therefore, it is not allowed to log in to the image forming device 2A (#113). Similarly, if the both passwords are not identical in the step #111 (No in #112), it is not allowed to log in (#113). In addition, if the user account information DT1 is not found either in the user account database 201 of the image forming device 2A or in the user account database 201 of the other image forming device 2 (No in #103 and No in #108), it is not allowed to log in since the user authentication cannot be performed (#113).

Note that the user can log in to the image forming device 2 from a remote location by operating the terminal device 3. In this case, the user enters his or her user ID and password first into the terminal device 3, so that user authentication is requested to the image forming device 2. Then, each portion of the image forming device 2 performs the process shown in FIG. 5 as described above in accordance with the user ID and password transmitted from the terminal device 3, so that a type of the user (a home user or an away user) as well as permission or refusal of logging in is determined.

With reference to FIG. 4 again, the job execution control portion 207 accepts the process specifics (a type and conditions of the process) designated by the user operating the control panel 20f or the terminal device 3 after logged in to the image forming device 2, in the same way as the conventional method. Then it controls hardware and software that constitute the image forming device 2 so that the job is executed in accordance with the process specifics.

The personal box management portion 208 generates a personal box KB newly in the local hard disk drive 20d, adds a file such as an image file to the personal box KB, retrieves or deletes a file from the personal box KB, extracts information about a file stored in the personal box KB (for example, a file name, a box name of the personal box KB in which the file is stored, a file size, a generation date etc.), deletes the personal box KB from the local hard disk drive 20d, and performs other processes concerning management of the personal box KB. Other than these, it also performs a process for moving the personal box KB that is provided to the hard disk drive 20d of the other image forming device 2 and files therein to the local hard disk drive 20d, and a management of a box shared by plural users (hereinafter referred to as a “common box CB”).

The box type discrimination portion 209 determines a type of the box in which the designated file is stored (a personal box or a common box).

The image file transmission portion 212 performs a process of retrieving a file such as an image file requested by another image forming device 2 from the personal box KB and transmitting the same to the other image forming device 2. The image file reception portion 213 performs a process of requesting the other image forming device 2 to send a file such as an image file and receiving the same.

The box file information transmission portion 214 performs a process of transmitting information about the file stored in the personal box KB that is requested by the other image forming device 2 (for example, a file name, a file size or a generation date) to the other image forming device 2. The box file information requesting portion 215 performs a process of requesting the image forming device 2 to send the information about the file stored in the personal box KB and receiving the same. This information is used for setting a link to the file, which will be described later. Hereinafter the information may be referred to as “link information”, therefore.

Next, process specifics of each portion of the image forming device 2 shown in FIG. 4 will be described more in detail with reference to flowcharts.

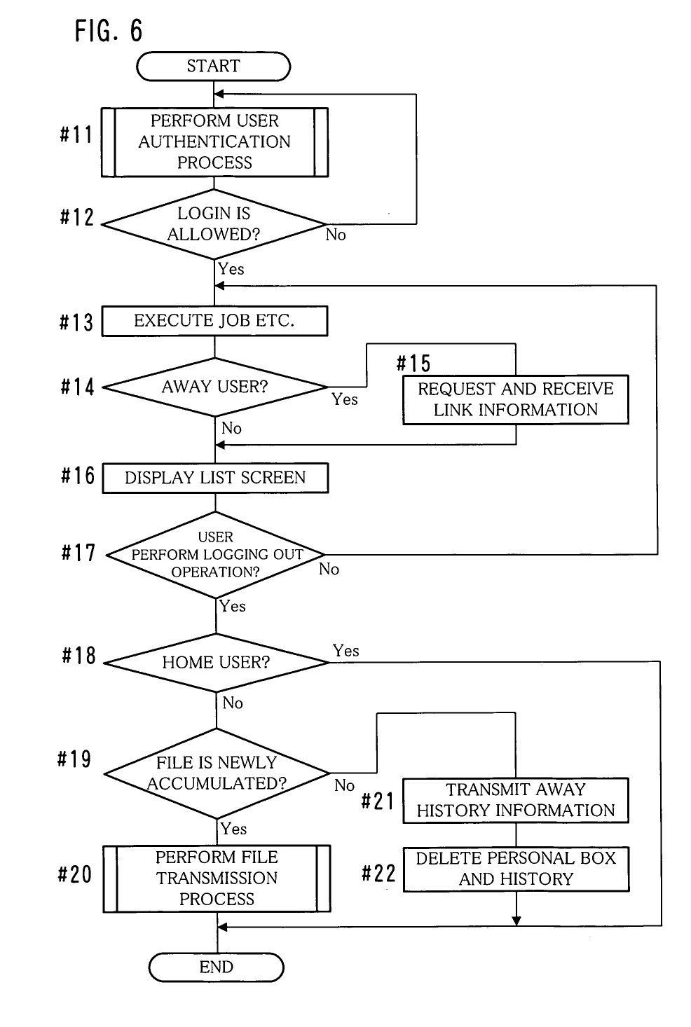

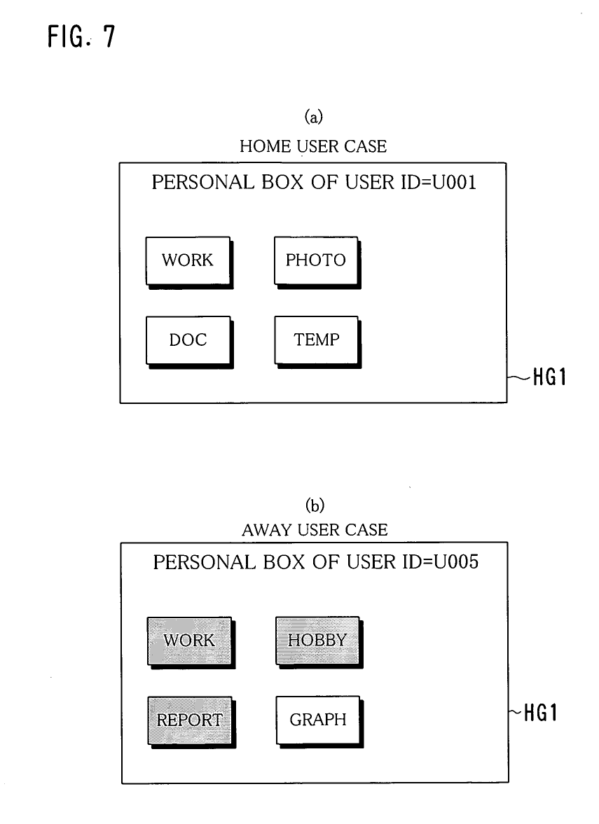

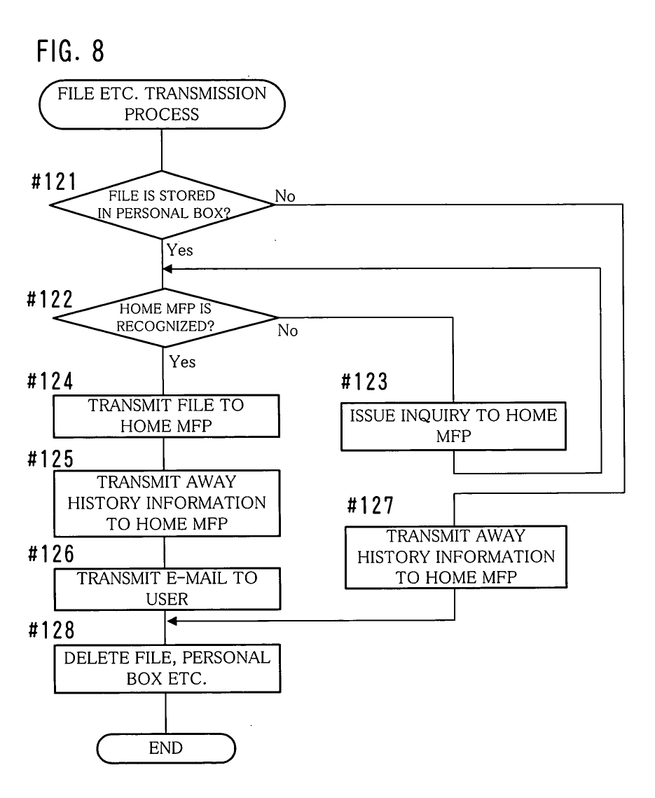

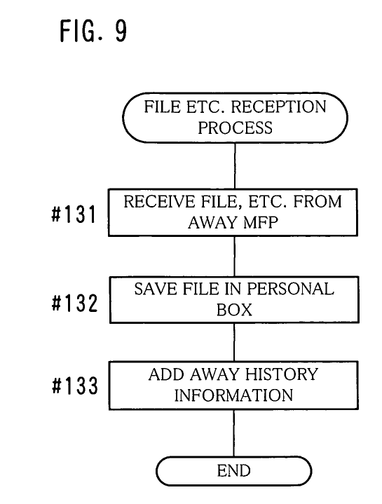

FIG. 6 is a flowchart showing an example of a flow of a general process of the image forming device 2, FIGS. 7(a) and 7(b) are diagrams showing examples of an inbox file list screen HG1, FIG. 8 is a flowchart showing an example of a flow of a file transmission process, and FIG. 9 is a flowchart showing an example of a flow of a file reception process.

When a user enters a user ID and a password in an image forming device 2, the user type discrimination portion 203 of the image forming device determines whether the user is a home user or an away user. The user authentication portion 206 performs user authentication of the user (#11 in FIG. 6).

If the user is a home user, the user account information DT1 of the user stored in the local user account database 201 is used for the user authentication. If the user is an away user on the contrary, the home MFP searching portion 204 searches a home MFP of the user, and the account information requesting portion 205 obtains the user account information DT1 of the user from the home MFP. Then, the user account information DT1 thus obtained is used for the user authentication. The procedure of these processes is as described above with reference to FIG. 5. The obtained user account information DT1 is stored in the local user account database 201 temporarily.

When the user is authenticated, the user is allowed to log in to the image forming device 2 (Yes in #12) and can make the image forming device 2 perform a desired job until logging off.

When the job execution control portion 207 is given an execution instruction and process conditions of the job by the user, it controls each portion of the image forming device 2 so that the job is executed in accordance with the process conditions (#13). In the process of executing the job or as a result of executing the job, data such as image data may be obtained. For example, in the process of executing the PC print job, image data of a document to be printed are received from the terminal device 3. Otherwise, as a result of executing the scan job, image data of a scanned original are generated. The personal box management portion 208 stores these data such as image data as a user's file in the personal box KB of the user that is provided to the hard disk drive 20d of the image forming device 2 (i.e., a local one), if necessary. Note that the job of storing the image data obtained by scanning in the personal box KB may be called “SCAN TO BOX” or the like.

Alternatively, the file can be stored in the common box CB instead of the personal box KB.

However, if the user who logged in is an away user for the image forming device 2, the personal box KB of the user may not be provided in the hard disk drive 20d of the image forming device 2. Therefore, the personal box management portion 208 provides the personal box KB of the user temporarily.

The user can use a file stored in his or her personal box KB or the common box CB that is provided to the image forming device 2, so as to perform the print job, the fax transmission job or the like. In this case, the screen display control portion 202 makes the display device 20f1 display the inbox file list screen HG1 that is a list screen of the file stored in the personal box KB or the common box CB as shown in FIG. 7(a) or FIG. 7(b) (#16).

Each button on the inbox file list screen HG1 corresponds to a file stored in the box, and a button name indicates a file name of the file corresponding to the button. The user selects a file to be used for the job by pressing the button corresponding to the file. Then, the job execution control portion 207 uses the selected file so as to execute the job. If the user logged in by using the terminal device 3, the screen display control portion 202 transmits the screen data to the terminal device 3 so that the terminal device 3 can display the inbox file list screen HG1.

However, if the user is an away user for the image forming device 2 (Yes in #14), the screen display control portion 202 displays the inbox file list screen HG1 so as to indicate not only a file in the user's local personal box KB but also a file in the personal box KB of the user's home MFP. In this case, the process is performed in the procedure as follows, for example.

The box file information requesting portion 215 requests the user's home MFP to send information of a file stored in the user's personal box KB that is provided to the home MFP (a file name, a box name of the personal box KB where the file is stored, and an IP address of the image forming device 2 to which the personal box KB is provided) (#15).

Then, in the home MFP the personal box management portion 208 extracts the requested information, and the box file information transmission portion 214 transmits this information as the link information DTL to the image forming device 2 that made the request.

Concerning the image forming device 2 that made the request, the link information DTL transmitted from the home MFP is stored (saved) in the user's personal box KB. If plural files are stored in the personal box KB of the home MFP, the link information DTL of each of the files is stored. Then, the screen display control portion 202 displays the inbox file list screen HG1 including buttons for files stored in the personal box KB of the home MF and buttons for files stored in the local personal box KB in accordance with the link information DTL stored in the personal box KB (#16).

In this case, however, a display form of a button that corresponds to a file stored in the personal box KB of the home MFP is made different from a display form of a button that corresponds to a file stored in the local personal box KB of the image forming device 2. For example, as shown in FIG. 7(b), the button of the file stored in the personal box KB of the home MFP is meshed with half-tone dots in the display of the inbox file list screen HG1. In other words, the half-tone dot meshed button plays a role in linking to a file stored in the other image forming device 2.

Here, the user selects a file that he or she desires to use by pressing the button with its file name in the same manner as the case shown in FIG. 7(a). Then, if the selected file is stored in the local personal box KB, the job execution control portion 207 retrieves the file from the personal box KB so as to execute the job. On the contrary, if the selected file is stored in the personal box KB of the user's home MFP, the image file reception portion 213 downloads the file from the home MFP in accordance with the link information DTL of the file. Then, the job execution control portion 207 uses the downloaded file so as to execute the job.

In addition, a user can operate directly a file stored in his or her local personal box KB. For example, a user can copy a file stored in a memory card or in the terminal device 3 to the personal box KB, and the user can also copy a file stored in the personal box KB to the memory card or to the terminal device 3.

Every time when a job is executed or a file is copied or moved in this way, its history (process specifics, a file name, date and time, and the like) is written in the history information DT2 of the user stored in the local user account database 201. Other than these, time and date of logging in, time and date of logging out, and identification information of the image forming device 2 of logging in (for example, an IP address thereof) are also written in the history information DT2 as necessity. Furthermore, if an away user logged in, history information DT2 of the away user is generated and stored in the local user account database 201 temporarily. Then, similarly to the case of a home user, these items are written in the history information DT2.

The process of the steps #13 and #16 are executed as necessity until the user logs out.

When the user performs the logging out operation (Yes in #17), the image forming device 2 performs the following process. If the user is an away user for the image forming device 2 (No in #18), the image forming device 2 checks whether or not there is a file that is newly stored (accumulated) in the box by the job execution control portion 207 or the personal box management portion 208 in accordance with an instruction of the user during the period after the user logs in until the user logs out. If there is such a file (Yes in #19), the image forming device 2 transmits the file to the user's home MFP (#20). This process is performed in the following procedure as shown in FIG. 8 for example.

If the file is stored in the user's personal box KB (Yes in #121 shown in FIG. 8), the image file transmission portion 212 tries to connect to the home MFP of the user (an away user). If the home MFP cannot be recognized or connected (No in #122), it is considered that the communication function of the home MFP is in the off state or the communication line 4 has a failure. Therefore, an inquiry is issued to the home MFP (#123), or a connection is tried again after a certain time passes.

If the home MFP can be recognized and connected (Yes in #122), the file is associated with the user ID of the user so as to start a process of transmitting the file to the home MFP (#124). After the file is transmitted, information about transmission of the file this time (a file name, an IP address of the image forming device 2 that is the source of transmission, a box name of the personal box KB in which the file was stored, an IP address of the image forming device 2 that is the destination of transmission and the like) is written in the history information DT2 of the user. Then, logging out process is completed, and information about the logging out is written in the user's history information DT2.

In addition, the image file transmission portion 212 associates the history information DT2 with a user ID of the user and transmits the same to the home MFP (#125). For the home MFP, this history information DT2 can be regarded as information about history when a user used an away MFP. Hereinafter, therefore, the history information DT2 transmitted from the image forming device 2 that is an away MFP viewed from an image forming device 2 that is the user's home MFP may be referred to as “away history information”.

The electronic mail transmission portion 216 transmits electronic mail to the user who logged out for informing that a file is transmitted to the user's home MFP (#126). An electronic mail address of the user can be known by referring to the user account information DT1 of the user.

In contrast, if the file is stored in the common box CB (No in #121), it does not perform the transmission of the file to the user's home MFP but transmits only the history information DT2 after completion of logging out (#127). The transmission is not performed because it is not preferable to change the storage place of the file since it is considered that the file will be shared by other users later.

After the away user logged out, the user account information DT1 and the history information DT2 of the away user is deleted from the local user account database 201, and the away user's personal box KB and a file stored in the same are deleted from the local hard disk drive 20d (#128).

Alternatively, it is possible to transmit a copy of the file to the user's home MFP if the file is stored in the common box CB (No in #121). Of course, it is desirable that the file be left in the common box CB for other sharing users.

With reference to FIG. 6 again, if the file is not stored in the box during the period after the away user logs in until the user logs out (No in #19), only the history information DT2 is transmitted to the away user's home MFP after completion of the logging out process (#21). Then, the user account information DT1, the history information DT2 and the personal box KB of the away user are deleted from the local user account database 201 and the hard disk drive 20d (#22).

If the user is a home user for the image forming device 2 (Yes in #18), the logging out process is performed conventionally without deleting the user account information DT1, the history information DT2 and the personal box KB.

As described above, when an away user logs out after logging in to the image forming device 2, the image forming device 2 transmits files and the history information DT2 stored (saved) in the away user's personal box KB during the log-in period to the away user's home MFP.

When the files and the history information DT2 are transmitted, the image forming device 2 that is the user's home MFP performs a process in the procedure as shown in FIG. 9.

The image file reception portion 213 performs a process of receiving the files and the history information DT2 (#131). In other words, when it is detected that the files and the history information DT2 are transmitted, the image file reception portion 213 checks a user ID that is associated with the files and the history information DT2. Then, it stores (saves) the file in the personal box KB that corresponds to the user ID and is provided to the local hard disk drive 20d (#132). In addition, specifics of the transmitted history information DT2 (the away history information) are written in the history information DT2 that corresponds to the user ID and is stored in the user account database 201 (#133). In other words, the away history information is integrated with the history information DT2 stored in the user account database 201.

According to this embodiment, the user can use the file obtained when he or she used the away MFP, later by using his or her home MFP easily.

More specifically, on the conventional system, after the user comes back from a business trip to his or her branch office for example, the user has to access the away MFP and copy the file stored in the away MFP to his or her home MFP in order to use the file stored in the away MFP in the destination of the business trip. If the power of the away MFP is turned off, the user cannot copy a file and has to ask another user who belongs to the branch office of the business trip destination to turn on power of the away MFP. According to this embodiment, these problems are solved. A user can integrate files into his or her home MFP for convenient use even if the user uses any image forming device 2.

In addition, a file that is obtained when a user uses an away MFP is automatically deleted after transmitting the same to the home MFP. Therefore, this avoids complicated management of files in the away MFP. An administrator's burden can be reduced, and information leakage from the away MFP can be prevented so that security can be enhanced.

In addition, transmission of a file to the home MFP is performed at the timing when the user logs out from the away MFP. If the file is moved to the home MFP at once when the file is obtained by the away MFP, the user may ask another user in his or her branch office to send back the file from the home MFP to the away MFP when necessity of using the file occurs in the away MFP. This situation is inconvenient. According to this embodiment, such inconvenience can be avoided by transmitting the file at the timing when the user logs out from the away MFP.

In addition, the history information DT2 (away history information) recorded in the away MFP can be managed integrally in the user's home MFP.

Next, variations of this embodiment will be described. Here, description of a part that overlaps the contents of this embodiment will be omitted.

[Variation of timing for transmitting files or the like from the away MFP to the home MFP]

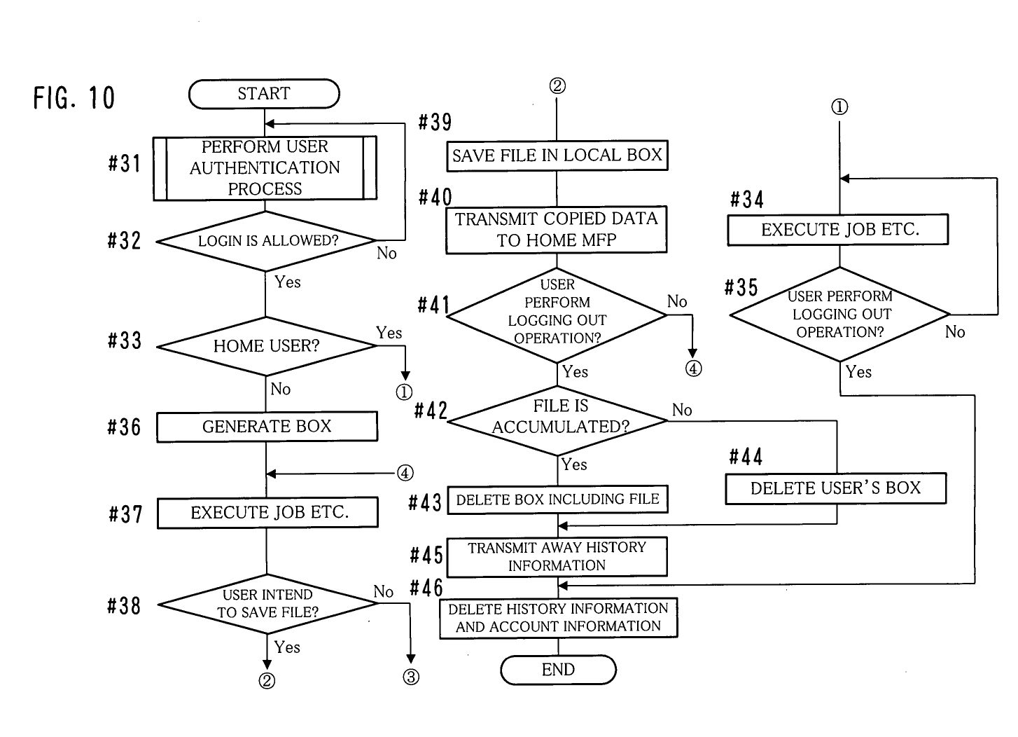

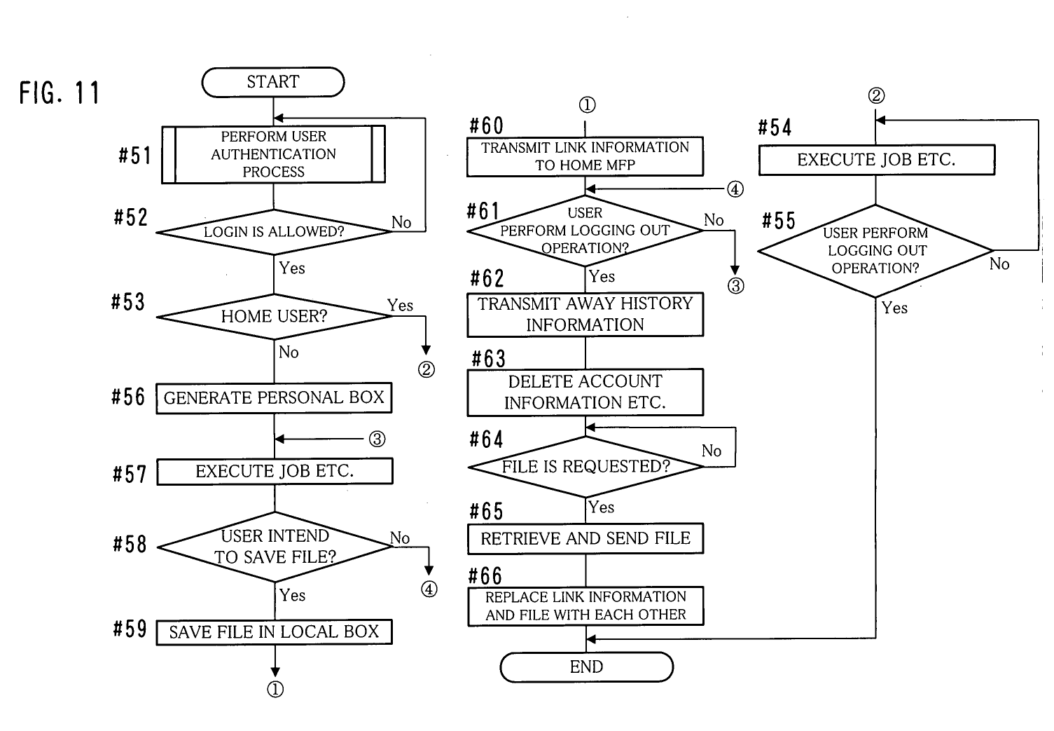

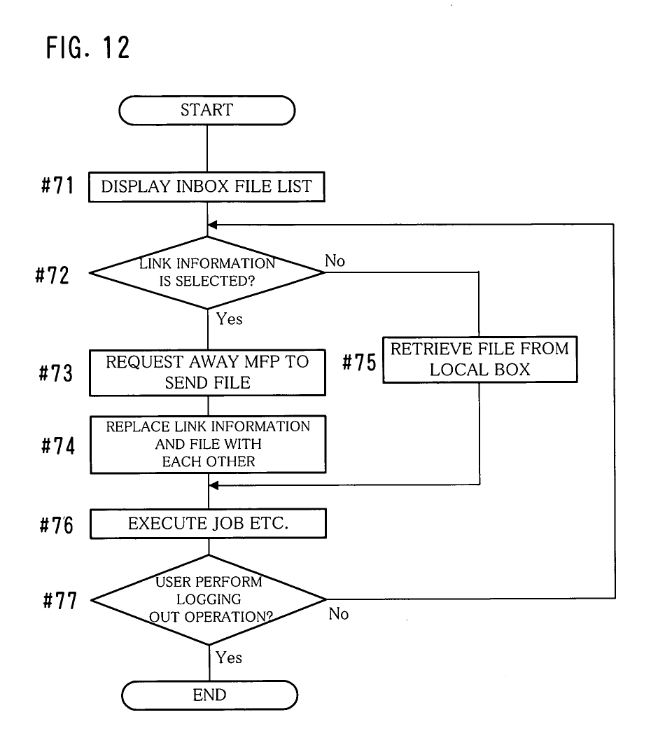

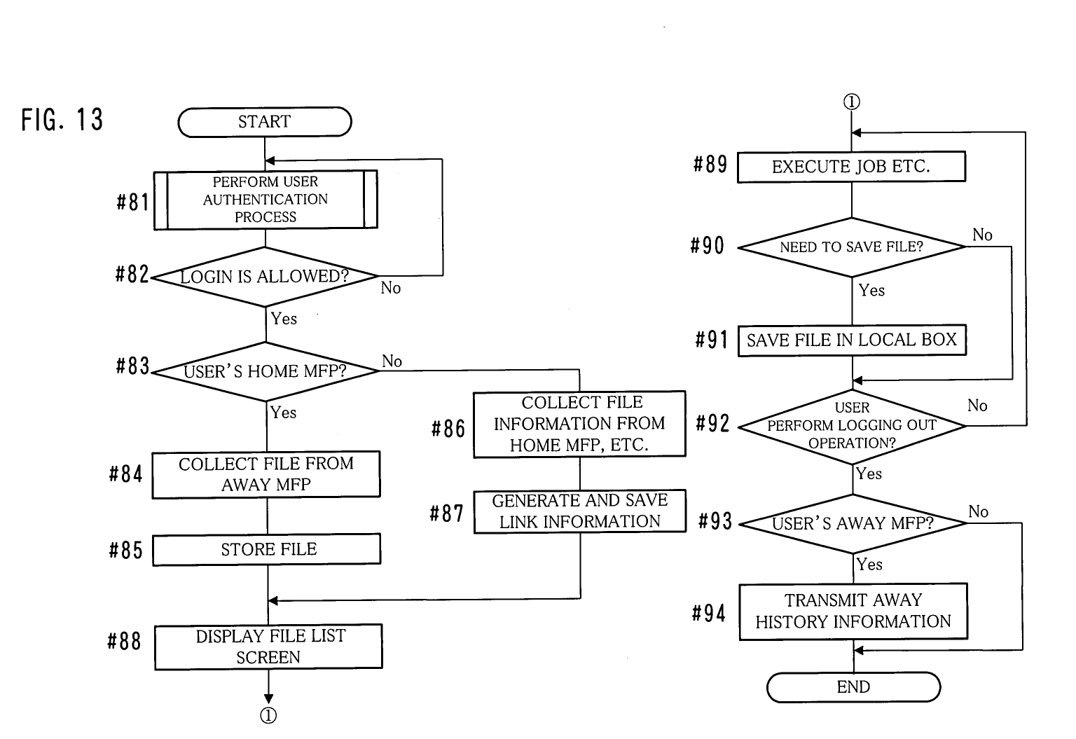

FIGS. 10 and 11 are flowcharts showing a variation of a flow of a process by the image forming device 2, FIG. 12 is a flowchart showing an example of a flow of a process by the image forming device 2 when a link button is selected, and FIG. 13 is a flowchart showing a variation of a flow of a process by the image forming device 2.

Although the image forming device 2 transmits files and history information DT2 of an away user to the away user's home MFP at the timing when the away user logs out in this embodiment, it is possible to transmit the same not at once when the user logs out but after a little while. For example, it is possible to transmit the files and the history information DT2 when the date changes.

Alternatively, it is possible to transmit the same before the user logs out. For example, it is possible to transmit the file to the user's home MFP every time when the file is obtained. In this case, for example, the process may be performed in the procedure as shown in FIG. 10. Hereinafter, the procedure of the process will be described by an example of the case where a user logs in to the image forming device 2A for performing a job.

In the image forming device 2A, the user type discrimination portion 203, the home MFP searching portion 204, the account information requesting portion 205 and the user authentication portion 206 (see FIG. 4) perform a process of determining a type of the user who is going to use the image forming device 2A (a home user or an away user) and an authentication process (#31 shown in FIG. 10). The procedure of this process is as described above with reference to FIG. 5. In addition, if the user is an away user for the image forming device 2A, user account information DT1 of the user is obtained from the user's home MFP.

When the user is allowed to log in (Yes in #32), the user can make the image forming device 2A execute a desired process until logging out.

If the user is a home user (Yes in #33), the image forming device 2A executes a job or the like in accordance with an instruction from the user (#34).

If the user is an away user (No in #33), the image forming device 2A generates user's personal box KB in the hard disk drive 20d of the image forming device 2A itself (i.e., a local one) (#36). Then, similarly to the conventional system, the image forming device 2A performs the job in accordance with an instruction from the user (#37). As described above, data such as image data may be obtained in the process of executing the job or as a result of executing the job. If the user desires to save the data (Yes in #38), the user saves the data as a file in the user's personal box KB generated in the step #36 (#39) and copies the data so as to transmit the same to the user's home MFP (#40). Therefore, when the process of the step #40 is completed, the same file exists both in the image forming device 2A to which the user logs in currently and in the home MFP.

Furthermore, history about job execution and file transmission to the home MFP is written in the user's history information DT2 as necessity.

When the away user performs the logging out operation (Yes in #41), the image forming device 2A executes the following process.

If the file is stored in the away user's personal box KB that is a local one (Yes in #42), this file is deleted from the personal box KB (#43). As described in the step #40, this file is copied to the away user's home MFP. Therefore, when the file is deleted from the local personal box KB, the file is moved to the away user's home MFP as a result. In addition, the personal box KB is also deleted from the local hard disk drive 20d. If the file is not stored in the away user's personal box KB that is a local one (No in #42), the personal box KB is deleted (#44).

In parallel with or the process of deleting the personal box KB and the like or about at that time, the history information DT2 of the away user is transmitted to the home MFP (#45). Then, the user account information DT1 and the history information DT2 of the away user are deleted from the local user account database 201 (#46).

Alternatively, it is possible to leave the file of the away user in the local personal box KB after logging out and to transmit the file to the away user's home MFP responding to a request from the home MFP. In this case, for example, it is possible to perform the process in the procedure as shown in FIG. 11. Hereinafter, the procedure of the process shown in FIG. 11 will be described by an example of the case where a user logs in to the image forming device 2A so as to make it perform a job.

The process of the user authentication (#51) and the process in the case where the user is a home user for the image forming device 2A (#54) is the same as described above with reference to the other flowchart.

If the user who logged in is an away user (No in #53), the image forming device 2A generates user's personal box KB (#56) if it does not exist in the hard disk drive 20d of the image forming device 2A (i.e., a local one).

Then, similarly to the conventional system, the image forming device 2A executes a job in accordance with an instruction from the user (#57). As described above, data such as image data may be generated or obtained in the process of executing the job or as a result of executing the job. If the user wants to save the data (Yes in #58), the image forming device 2A stores the data as a file in the user's personal box KB that is a local one (#59).

The flow of the process heretofore is the same as the flow of the process described above with reference to FIG. 10. However, although the away MFP transmits a copy of a file stored in the personal box KB to the user's home MFP in the process shown in FIG. 10 (#40 in FIG. 10), it transmits information indicating a file name and a storage place of the file (i.e., an IP address of the image forming device 2A and a box name of the personal box KB) as the link information DT3 to the home MFP in the process shown in FIG. 11 (#60).

In this case, the home MFP stores the link information DT3 transmitted from the image forming device 2A in the user's personal box KB that is provided to the home MFP. A method of using the link information DT3 will be described later.

When the user who is an away user logs out (Yes in #61), the image forming device 2A transmits the history information DT2 of the user to the home MFP (#62). Then, the image forming device 2A deletes the user account information DT1 and the history information DT2 of the user (#63).

In contrast, the image forming device 2 that is an away user's home MFP performs the process as shown in FIG. 12. Hereinafter the procedure of the process will be described by an example of the case where the home MFP is the image forming device 2B.

When the user who logged out from the image forming device 2A logs in to the image forming device 2B that is his or her home MFP and performs a predetermined operation, the image forming device 2B displays the inbox file list screen HG1 as shown in FIG. 7(b) (#71 in FIG. 12). As described above, each button in the inbox file list screen HG1 corresponds to the file stored in the user's personal box KB. However, the button displayed with half-tone dot meshing corresponds to the file stored in a place indicated in the link information DT3 (i.e., the personal box KB of the away MFP).

Here, if the user presses a button that is not displayed with half-tone dot meshing (No in #72), a file in the local personal box KB is selected. Therefore, the image forming device 2B retrieves the selected file from the personal box KB in the same manner as the conventional system (#75), so as to use the file for executing the job or the like (#76).

If the user presses a button that is displayed with half-tone dot meshing (Yes in #72), a file that is indicated in the link information DT3 is selected. Therefore, the image forming device 2B downloads the file from the away MFP that was used by the user before (for example, the image forming device 2A) in accordance with the link information DT3. Then, the downloaded file is stored in the user's personal box KB that is a local one, and the link information DT3 indicating the original storage place of the file is deleted from the personal box KB (#74). In other words, the downloaded file and the link information DT3 are replaced with each other. Then, the image forming device 2B uses the file for performing the job or the like (#76).

With reference to FIG. 11 again, when the image forming device 2A is requested a file from the image forming device 2B (Yes in #64), the image forming device 2A retrieves the file from the local personal box KB and transmits the same to the image forming device 2B (#65). Then, the file is removed, and instead the link information that indicates a storage place of the file in the image forming device 2B is stored in the local personal box KB (#66). In other words, the file and the link information are replaced with each other.

Alternatively, even if the user who logged in to the image forming device 2 is an away user, it is possible that the file that is obtained or generated during the period after the user logged in to the image forming device 2 until the user logged out from the same is once stored in the user's personal box KB that is a local one and later the file is moved at the timing when the user logs in to the home MFP. In this case, the process may be performed in the procedure as shown in FIG. 13.

The image forming device 2 performs a process of user authentication of the user who is going to use the image forming device 2 and a process of determining a type of the user (#81 in FIG. 13). These process specifics are as described above with reference to FIG. 5.

When the home user logs in to the image forming device 2 (Yes in #82 and Yes in #83), the image forming device 2 requests the other image forming device 2 to send the file stored in the user's personal box KB that is provided therein locally and receives the same (#84). Then the file is stored in the user's personal box KB that is provided to the image forming device 2 locally (#85). In other words, the files are collected from the user's personal box KB in the away MFP for the user and are saved.

In contrast, if an away user logs in to the image forming device 2 (Yes in #82, No in #83), information (link information DTL) about the file stored in the user's personal box KB that is provided to the user's home MFP is requested and obtained (#86). Then, the link information DTL is stored in the user's personal box KB that is provided to the image forming device 2 locally (#87). Furthermore, if the personal box KB does not exist, it is generated in this occasion.

When the user performs a predetermined operation, the screen display control portion 202 displays the inbox file list screen HG1 as described with reference to FIG. 7(b) (#88). A structure of the inbox file list screen HG1 is the same as that described above, so description thereof will be omitted. If the button selected in the inbox file list screen HG1 corresponds to the file stored in the other image forming device 2, the file is downloaded from the other image forming device 2. However, it is possible to replace the file with the link information when it is downloaded as described above with reference to FIGS. 11 and 12. Alternatively, it is possible to delete the file after using the file without performing the replacement.

As described above, data (a file) may be obtained or generated every time when a job or the like is executed (#89) in the image forming device 2. If it is required to save the file (Yes in #90), it is stored in the user's personal box KB of the image forming device 2 regardless that the user is a home user or an away user according to the method shown in FIG. 13 (#91).

Then, after the user logs out, the history information DT2 of the user is transmitted to the user's home MFP if the user is an away user (#94). Note that the file is not transmitted here. The transmission of the file is performed at the timing when the user logs in to his or her home MFP next time.

[Variation of the process when logging in to the away MFP again]

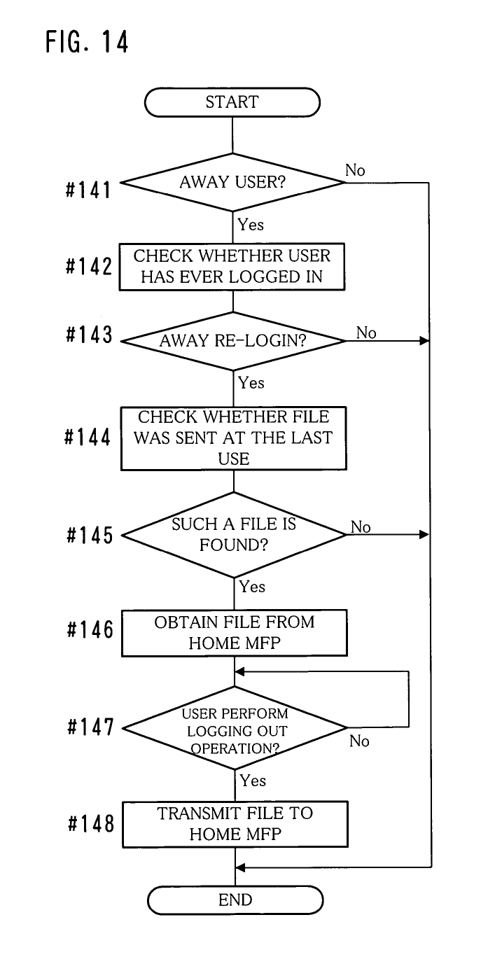

FIG. 14 is a flowchart showing an example of a flow of a process by the image forming device 2 when an away user logs in again.

In this embodiment or its variation, the user's files are collected finally in the user's home MFP if they are generated or obtained in the away MFP. However, the user may use again the away MFP that was once used by the user. Therefore, it is possible to design so that the user's file that was obtained before in the away MFP is moved to the away MFP temporarily when the user logs in to the away MFP again. In this case, the image forming device 2 that is an away MFP performs the process in the procedure as shown in FIG. 14. Note that management of files is mainly shown in FIG. 14, but processes such as the user authentication are omitted.

If the user who logged in is an away user (Yes in #141), the image forming device 2 obtains the history information DT2 of the user from the user's home MFP and checks whether or not the user has ever logged in to the image forming device 2 in accordance with the obtained history information DT2 (#142).

If the user has ever logged in (Yes in #143), the file that was stored in the user's local personal box KB at a predetermined time point (for example, the time point of the last logging out or a previous time point) is checked in accordance with the history information DT2 (#144). If there is such a file (Yes in #145), the file is downloaded from the user's home MFP and is stored in the user's local personal box KB temporarily (#146).

When the user logs out (Yes in #147), the file stored in the local personal box KB at the time point of logging out is transmitted to the user's home MFP (#148). Furthermore, similarly to the case of the other flowchart, the history information DT2 including history about the file process executed during the period after the user logs in until the user logs out is also transmitted to the home MFP.

[Other Variations]

If the personal box KB can have a directory structure, it is possible to transmit files together with the directory structure. For example, if a file to be transmitted is stored in the sub directory named “human resources documents” in the directory named “documents” in the personal box KB having the box name of “U001” in the away MFP, the file transmitted from the away MFP may be stored in the sub directory named “human resources documents” in the directory named “documents” in the personal box KB having the box name of “U001” in the home MFP. If the directory or the sub directory does not exist in the home MFP, it can be generated when the file is received. Furthermore, if the personal box KB of the box name does not exist, it can be generated when the file is received.

If the away MFP cannot make connection with the home MFP for transmitting a file from the away MFP to the home MFP, it is possible to save the file temporarily in the user's terminal device 3 or the like. Then, the saved file may be transmitted to the home MFP when the terminal device 3 can make connection with the home MFP.

Furthermore, the structure of the whole or a part of the intranet 1 and the image forming device 2, the process specifics, the process order or the like can be modified in accordance with the spirit of the present invention, if necessary.

The present invention can be used preferably for an image processing device such as MFP, particularly one that specific users use occasionally.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A data communication system comprising a first device and a second device that can be connected to each other via a communication line, wherein
the first device is provided with a first data storage portion for storing data owned by a user who uses the first device mainly; and
the second device is provided with a second data storage portion and a data transmission portion, the second data storage portion storing data that are owned by the user and obtained during a period after the user logs in to the second device until the user logs out, and the data transmission portion transmitting data stored in the second storage portion to the first device if the data is owned by a user who uses the first device mainly.

2. The system according to claim 1, wherein the data transmission portion transmits data after the user logs out from the device.

3. The system according to claim 1, wherein the second device is provided with a data deleting portion for deleting data from the second storage portion after the data were transmitted to the first device.

4. An image processing device for performing an image-related process that is a process about an image, comprising:
a data obtaining portion for obtaining data by performing the image-related process;
a data storage portion for storing data obtained by the data obtaining portion; and
a data transmission portion for transmitting to another image processing device the data that were obtained by the data obtaining portion and are owned by the user if the user who logged in to the image processing device is a guest user who usually uses the other image processing device.

5. The device according to claim 4, further comprising a data deleting portion for deleting from the data storage portion the data that were transmitted to the other image processing device by the data transmission portion.

6. The device according to claim 4, wherein the data transmission portion transmits the obtained data after a user who owns the data logs out from the image processing device.

7. The device according to claim 5, wherein the data transmission portion transmits data immediately when the data that the user who is the guest user owns are obtained by the data obtaining portion, and the data deleting portion deletes the data transmitted to the other image processing device by the data transmission portion after the user who owns the data logs out from the image processing device.

8. The device according to claim 4, further comprising a data identification information transmission portion for transmitting data identification information for identifying data to the other image processing device where the data are used mainly every time when the user' data obtained by the data obtaining portion is stored in the data storage portion if the user who logged in to the image processing device is the guest user, wherein the data transmission portion transmits data to the other image processing device when the other image processing device requests the data in accordance with the data identification information.

9. The device according to claim 4, wherein the data storage portion is provided with a common storage area that is a storage area for storing data shared by plural users, and the data transmission portion does not transmit data stored in the common storage area.

10. The device according to claim 5, wherein the data storage portion is provided with a common storage area that is a storage area for storing data shared by plural users, and the data deleting portion does not delete data stored in the common storage area.

11. The device according to claim 4, further comprising:
a user type determining portion for determining whether a type of the user is the guest user or a home user who mainly uses the image processing device;
a download portion for downloading the user's data stored in the other image processing device to make the data storage portion store the user's data when the user type determining portion determines that the type of the user who logged in to the image processing device is the home user;
a data identification information obtaining portion for obtaining data identification information for identifying the user's data stored in the other image processing device when the user who logged in to the image processing device is the guest user; and
a data list display portion for displaying a list of data owned by the user who logged in to the image processing device among data stored in the data storage portion or in the other image processing device, in accordance with the data identification information.

12. A method for managing data in an image processing device that can be connected to another device via a communication line, the method comprising the steps of:
storing data in a data storage portion, the data being obtained during a period after a user logs in to the image processing device until the user logs out from the same; and
transmitting the user's data stored in the data storage portion to another image processing device via the communication line if the user is a guest user who uses the other image processing device mainly.

13. The method according to claim 12, wherein data owned by the user who is a guest user and uses another image processing device mainly is transmitted to the other image processing device at a predetermined timing.

14. The method according to claim 13, wherein the predetermined timing is timing when the user logs out from the image processing device.

15. The method according to claim 12, wherein the data transmitted to the other image processing device is deleted from the data storage portion.

16. The method according to claim 12, wherein the data owned by the user who is a guest user using the other image processing device mainly are transmitted to the other image processing device as soon as the data is obtained, and the data that is transmitted to the other image processing device is deleted after the user who owns the data logs out from the image processing device.

17. The method according to claim 13, wherein data identification information for identifying data is transmitted to the other image processing device every time when the user's data that was obtained is stored in the data storage portion if the user who logged in to the image processing device is the guest user who uses the other image processing device mainly, and data are transmitted to the other image processing device at the timing when the other image processing device requests for the data in accordance with the data identification information.

18. The method according to claim 12, wherein the data storage portion is provided with a common storage area that is a storage area for storing data shared by plural users, and the data stored in the common storage area are not transmitted.

19. The method according to claim 12, wherein the data storage portion is provided with a common storage area that is a storage area for storing data shared by plural users, and the data stored in the common storage area are not deleted.

20. The method according to claim 12, further comprising the steps of:
determining whether a type of the user is the guest user who uses the other image processing device mainly or a home user who uses the image processing device mainly;
downloading the user's data stored in the other image processing device and storing the data in the data storage portion if the type of the user who logged in to the image processing device is determined to be the home user;
obtaining data identification information for identifying the user's data stored in the other image processing device if the type of the user who logged in to the image processing device is determined to be the guest user who uses the other image processing device mainly; and
displaying a list of data owned by the user who logged in to the image processing device among data stored in the data storage portion or in the other image processing device, in accordance with the data identification information.
